(19) United States
(12) Patent Application Publication
(10) Pub. No.: US 2004/0195791 A1
(43) Pub. Date: Oct. 7, 2004

(54) Wheeled backpack

(76) Inventor: Luella Brookes-Inglis, South Australia (AU)

Correspondence Address: LEYDIG VOIT & MAYER, LTD, 700 THIRTEENTH ST. NW, SUITE 300, WASHINGTON, DC, 20005-3960, US

(21) Appl. No.: 10/479,806

(22) PCT Filed: Jun. 14, 2002
(86) PCT No.: PCT/AU02/00782

(30) Foreign Application Priority Data
Jun. 14, 2001 (AU) PR 5665

(51) Int. Cl. B62B 1/00

(52) U.S. Cl. 280/47.26

(57) ABSTRACT

The present invention relates to a wheeled backpack, particularly for use by children and young adults at education facilities, including: a bag portion having an outer periphery including a body contacting side, an opposing non-body contacting side, a bottom surface and two opposing side surfaces, and an inner periphery within which items may be stowed; shoulder straps attached to the bag portion, adapted to located on the body contacting side and hung on a wearer's shoulders; a spine support located on the body contacting side for supporting the spine of a wearer; a handling means having an extendable shaft, the shaft being located within the spine support; at least two spaced apart wheels, the wheels being attached to the same or different axles at attachment portions; the axle or axles being attached to the backpack on or near the body contacting side and extending beyond the side surfaces so that the attachment portion of the axle(s) is beyond the outer periphery to externally locate the wheels attached thereto beyond the outer periphery of the bag portion.

### FIELD OF THE INVENTION

The present invention relates to wheeled backpacks, particularly for use by children and young adults at education facilities.

### BACKGROUND OF THE INVENTION

It is recognised that the demands placed on students in the modern school system can cause long-term damage to their backs. Students may attend over eight different classes in one day with each class requiring the student to bring one or more textbooks. The weight of required textbooks, binders, gym gear, laptop computers and other school supplies may be very heavy and beyond that safely carried by a young, developing back. With the recognition of the risk this can pose to a student, some schools have been providing lockers for use by students and parents have been urged to buy back safe luggage, in the form of backpack for use by their children. However, these means are not enough and as such there is a real need to provide a safer means for transporting heavy loads.

One such means is the use of a wheeled backpack. The use of wheels on a backpack permits a heavy pack to be pulled or pushed along for long distances by the owner without the need to carry the pack and thereby reduce the likelihood of back damage. However for various reasons, none of the known attempts appear to have been commercially successful.

The following is a brief discussion of various disclosures made in a number of patents or patent applications. It is expressly, stated that the discussion should not be taken as an acknowledgment that the disclosures and the information therein is of common general knowledge in Australia or other jurisdictions.

U.S. Pat. No. 5,676,286 (Ann Song) describes a wheeled knapsack for use by students and other persons. It includes at least two wheels attached away from the body-contact side of the bag portion to avoid contact thereof with the wearer's body and to prevent the straps of the backpack from coming into contact with the ground. A handle, in the form of a U shaped handle or strap is attached to the non body-contact side in order to permit the pulling of the knapsack.

U.S. Pat. No. 5,893,495 (Godshaw et al) describes a conversion apparatus for a backpack. The document discloses a backpack styled luggage item having a U shaped extendible handle and a pair of wheels, both located near the body contact side of the bag portion. The wheels are small and are internally fitted within the bag space with a pad over the body facing side. The backpack includes a tether between the straps of the backpack and a portion of the extendible handle so to retract the straps out of the way when the handle is extended.

U.S. Pat. No. 5,749,503 (Wulf et al) describes a luggage container that converts into a wheeled suitcase, a backpack and a hand-carry bag. The bag includes a U shaped extendible handle and wheels mounted within recesses in the bag. A portion of the bag covers the backpack straps during its use in the wheeled configuration. The portion is folded over the wheels when it is used in the backpack configuration.

U.S. Pat. No. 4,368,835 (Murphy) describes a wheeled backpack. The pack is formed from spaced apart tubular members, to which the bag and straps are attached. Two shafts supporting wheels fit within the tubular members, and position the wheels at a distance from the bag.

None of the above backpacks appear to have been successfully commerciallsed. It is thought that the reasons for this may be that the bags are too costly to manufacture, too difficult to operate and importantly fail to provide a backpack that is fashionably acceptable.

### OBJECT OF THE PRESENT INVENTION

It is an object of the present invention to provide a commercially acceptable backpack that overcomes at least some of the disadvantages of the prior art.

### BRIEF DESCRIPTION OF THE INVENTION

The present invention includes a wheeled backpack including:

a bag portion having an outer periphery including a body contacting side, an opposing non-body contacting side a bottom surface and two opposing side surfaces, and an inner periphery within which items may be stowed;

shoulder straps attached to the bag portion, adapted to located on the body contacting side and hung on a wearer's shoulders;

a spine support located on the body contacting side for supporting the spine of a wearer;

a handling means having an extendable shaft, the shaft being located within the spine support;

at least two spaced apart wheels, the wheels being attached to the same or different axles at attachment portions;

the axle or axles being attached to the backpack on or near the body contacting side and extending beyond the side surfaces so that the attachment portion of the axle(s) is beyond the outer periphery to externally locate the wheels attached thereto beyond the outer periphery of the bag portion.

### BRIEF DESCRIPTION OF THE DRAWINGS

In the drawings, which illustrate a preferred embodiment of the invention:

FIG. 1 is a perspective view of the front of an embodiment of the invention.

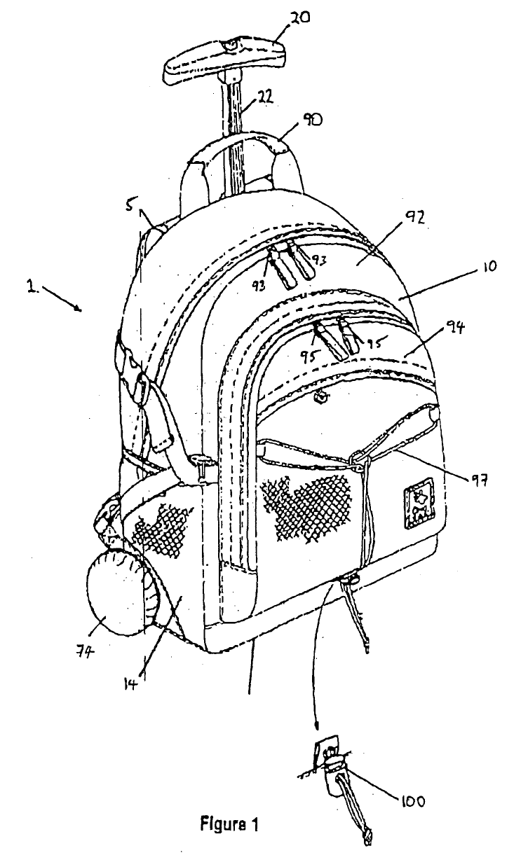

FIG. 2 is another perspective view of the front of the embodiment of the invention shown in FIG. 1.

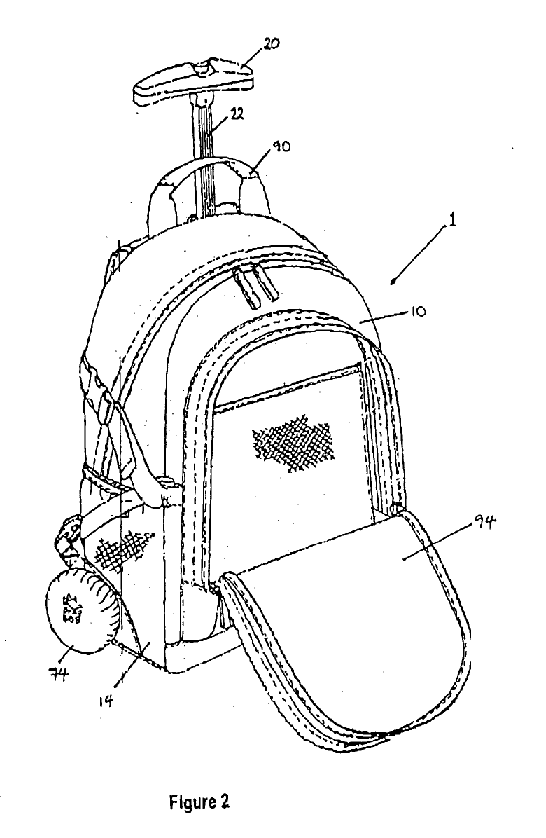

FIG. 3 is perspective view with a cut away portion of the front of the embodiment of the invention shown in FIG. 1.

FIG. 4 is perspective view of the rear of the embodiment of the invention shown in FIG. 1.

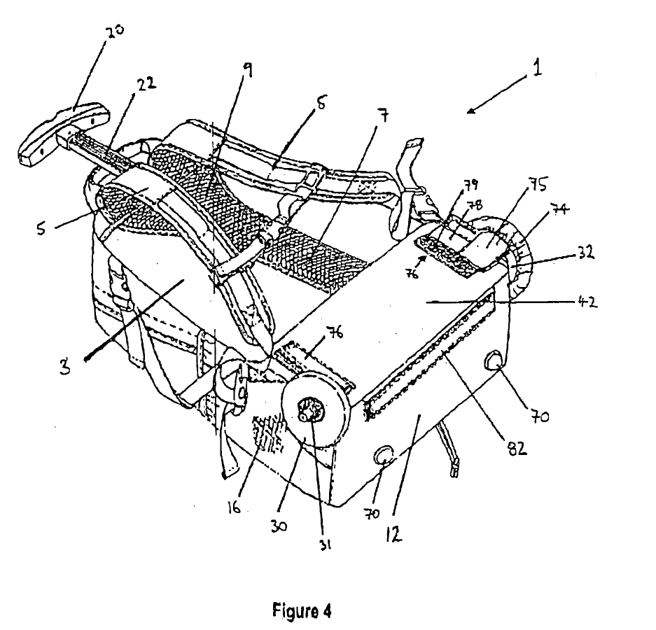

FIG. 5 is another perspective view of the rear of the embodiment of the invention shown in FIG. 1.

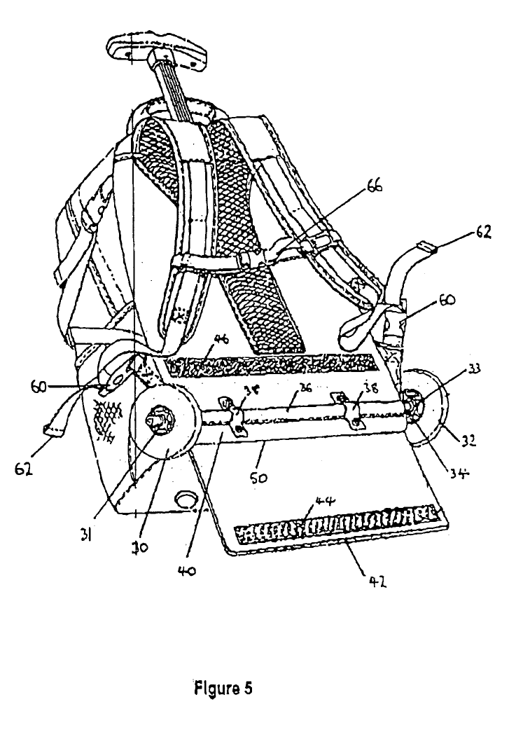

FIG. 6 is another perspective view of the rear of the embodiment of the invention shown In FIG. 1.

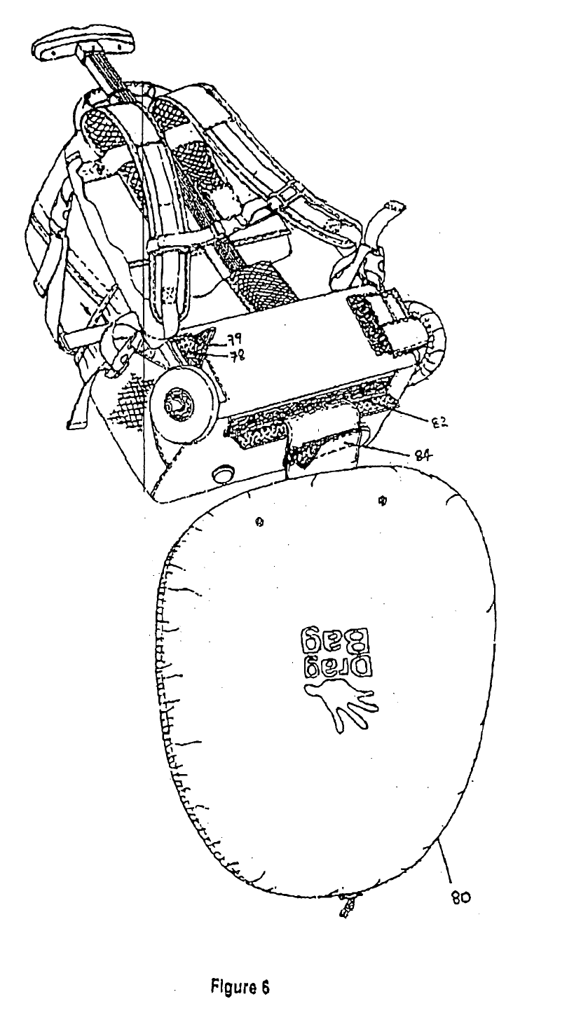

### DETAILED DESCRIPTION OF THE INVENTION

The invention is based on the idea of prominently locating wheels on the backpack in order to make the wheels a desirable feature of the backpack, and thereby improve the acceptance of such packs by the consumers.

It is also based on a desire to provide for a good carrying capacity without unduly increasing the weight and size of the backpack. Accordingly the wheels and handling means shaft must be located so that they minimise their impingement upon the internal periphery of the bag portion of the backpack.

It was found that the spine support used in supporting the spine of a wearer could be used to locate an extendible shaft of a handling means. The handling means should have a handle attached to an extendable shaft located within the spine support in order to minimise impingement on the internal periphery of the bag. It is thought that the handling means could have a plurality of shafts to provide a U shaped handling means or a single shaft capped with a cross bar to provide a T shaped handling means. Preferably the handling means is ‘T’ shaped, as this should add less weight to the backpack and can be more easily incorporated into the spine support by incorporating it into a central channel in a preferably padded spine support.

It will be appreciated that the backpack would not be worn with the handle extended and as such it does not matter if the spine support does not function as a spine support once the handle has been fully extended.

The other important aspect of the invention relates to the positioning of the wheels relative the outer periphery of the bag portion of the backpack. In order to promote the use of wheels the wheels should be located wholly external to the bag portion. This can be done by having at least two spaced apart wheels being attached to the same or different axles at attachment portions on the axles, where the axle or axles are attached to the backpack on or near the body contacting side, and where the axle or axles extend beyond the side surfaces so to locate the attachment portions of the axle or axles beyond the outer periphery of the bag.

Positioning the wheels on the backpack so that they are not integrated in part within the backpack can promote the use of the wheels and also confer a number of other advantages to the backpack. It was found that by using external wheels the backpack could be wheeled up stairs as a portion of the wheels could engage the surfaces of the stairs, rather than a portion of a fixed wheel cover. Furthermore the use of wholly external wheels provides ready access to the wheels for the purpose of cleaning and servicing. In a preferred embodiment the wheels are attached to the axle(s) by a releasable securing means, such as a split pin or wing nut. The location of the wheels external to the bag portion should permit easier changing of the wheels.

It will be appreciated that the prominent positioning of the wheels will allow the wheels to be used as a media for incorporating various promotional materials or for character merchandising. It is envisaged that the wheels may have thereon various popular characters, such as Digimon characters or creatures encased therein (for wheels made from transparent materials) such as spiders. The owners could change the wheels and designs thereon or therein as fashions change.

The invention will now be described with reference to the figures, which illustrate a preferred embodiment of the invention.

The figures show a backpack (1) of the present invention. The pack includes a body contacting side (3), an opposing non-body contacting side (10), a bottom surface (12) and two opposing side surfaces (14) and (16). On the body contacting side there are shoulder straps (5) for contacting the shoulders of a wearer. It should be understood that the straps (5) need not be attached to the body contacting side but simply need to be located on the body contacting side for use by a wearer.

The body contacting side also includes a spine support (7) for supporting the spine of a wearer. The spine support may include a wider upper portion (9) for providing additional support in the upper back region and also for provided an improved connection between the straps (5) and the bag portion. It is envisaged that the spine support will comprise a rigid core with an outer padded surface in order to provide a comfortable fit for the wearer.

The backpack also includes a ‘T’ shaped extendible handle having a cross bar (20) and an extending shaft (22). The shaft fits within a channel located within the spine support (7 & 9).

The backpack also includes a pair of wheels (30) and (32). These wheels are attached to a common axle (34) at attachment points (31) and (33). The axle is located within a hollow tube (36) affixed by brackets (38) to a lower portion (40) of the body contacting side. A padded section (42) is held in place over tube (36) and brackets (38) by hook (44) and loop (46) fasteners in order to avoid discomfort to a wearer.

Of course the wheels may have been attached to separate axles or the axle(s) could have been attached to the bottom surface (12) of the bag. If the axle(s) where affixed to the bottom surface of the bag, the axles would need to be positioned near the edge (50) between the bottom surface (12) and the body contacting side (3) in order to permit easy wheeling of the bag. The axle or axles may be located external to the body of the bag or may be incorporated within a compartment located within the bag portion.

The backpack as shown includes a number of additional features that provide for added functionality. The straps (5) may be adjusted to fit the particulars of a wearer by the adjustment devices (60). The end of the straps (62) can be pulled through the devices (60) to change the effective length of the straps. The straps also include a cross-brace (66) to allow for a more comfortable fitting of the backpack to a wearer.

The bottom of the pack may include resting points (70) near the non-body contacting side. The backpack may be stood up on the resting points and the wheels, with the resting points acting as anchor points to prevent the movement of the backpack.

The backpack may include wet weather wheel protectors (74) in order to reduce the likelihood of mud or other filth being transferred to the back of the wearer. The wet weather wheel protectors are normally located in pockets (76) kept closed with hook (78) and loop (79) fasteners within the lower padded section (42). One end of the protector is fixed within the pocket and is joined by a connecting portion (75) to the portion wrapped around a wheel (32) to enclose the likely back contacting surface of the wheel in a plastic sheath (74).

The backpack may also include a wet weather cover for the backpack (80). This cover would normally be located within a pocket (82) possibly located in the bottom side of the pack. This cover may be releasably attached (84) to the backpack by anymeans possible such as hook and loop fasteners in order to permit easy cleaning of the cover or for the customising of the cover. It is envisaged that as the cover provides a significant area for the inclusion of promotional material, education institutions could require the inclusion of particular indicia to identify and promote the education institution.

The backpack may also include a strap handle (90) for moving the backpack around short distances. The pack may include a number of different sections, such as a main body section (92) and a smaller section (94), each with separate access via a fastener means such as zippers (93) and (95). In one embodiment the smaller section is adapted for use in carrying wet clothing by for example having an open mesh front portion. The smaller section may also provide a restraining means, such a string portion (97) for the storage of a detachable container portion (not shown). The tension of the string portion could be adjusted by the locking device (100) shown in the enlarged section.

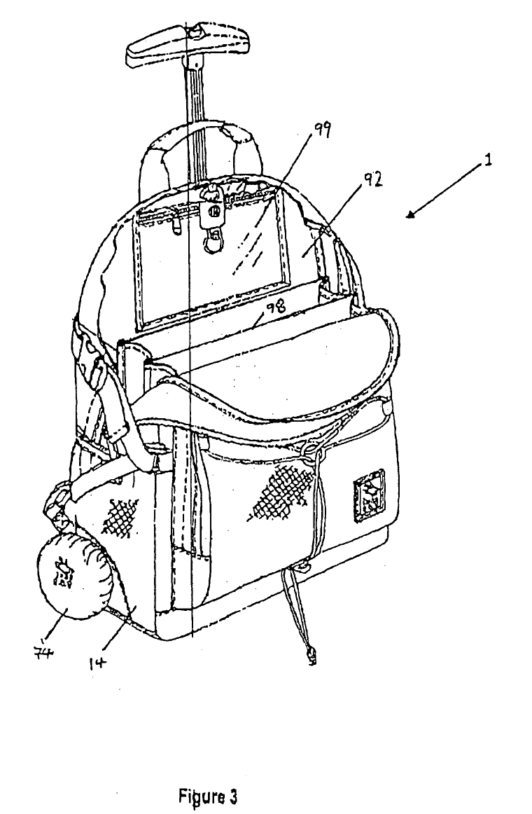

The main body portion may itself be divided into a number of sections by the inclusion of internal dividers (98) or by having further compartments (99), as shown in FIG. 3, wherein a portion of the main body section has been removed. The backpack may also include a tether linked to the handle and the shoulder straps. The tether should lift the straps upwards when the handle is extended for wheeling the bag.

In use in the wheeled configuration the handle is fully extended and the backpack is tilted by pulling on the handle so that it pivots about the wheel. The use of a rigid handle will permit the backpack to be pushed or pulled to a desired location. The use of large external wheels permits the backpack to e pulled upstairs, a step at a time.

The above description is provided for the purposes of exemplification only and it will be understood by a person skilled in the art that modifications and variations may be made without departing from the spirit of the invention. Such modifications and variations should be considered within the scope of the invention.

1. A wheeled backpack including:
a bag portion having an outer periphery including a body contacting side, an opposing non-body contacting side, a bottom surface and two opposing side surfaces, and an inner periphery within which items may be stowed;
shoulder straps attached to the bag portion, located on the body contacting side, for hanging on a wearer's shoulders;
a spine support located on the body contacting side for supporting the spine of a wearer;
handling means having an extendable shaft, the shaft being located within the spine support;
at least two spaced apart wheels; and
one or more axles attached to the backpack on or near the body contacting side and extending beyond the side surfaces and having respective attachment portions, the wheels being attached to the one or more axles at respective attachment portions, wherein the attachment portions are beyond the outer periphery to locate the wheels beyond the outer periphery of the bag portion.

2. The wheeled backpack according to claim 1 wherein the wheels and the handling means shaft do not impinge upon the internal periphery of the bag portion of the backpack.

3. The wheeled backpack according to claim 2 wherein the spine support includes a wider upper portion to provide support in the upper back of a wearer and connecting the shoulder straps and the bag portion.

4. The wheeled backpack according to claim 3 wherein the spine support includes a rigid core with an outer padded surface providing a comfortable fit for a wearer.

5. The wheeled backpack according to claim 4 wherein the handling means includes a plurality of shafts to provide a U-shaped handling means.

6. The wheeled backpack according to claim 4 wherein the handling means includes a single shaft with a cross bar to provide a T-shaped handling means.

7. The wheeled backpack according to claim 6 including a central channel in the spine support in which the handling means is incorporated.

8. The wheeled backpack according to claim 7 in which the handling means, once the shaft is unextended, provides spine support.

9. The wheeled backpack according to claim 2 in which the wheels are of sufficient size such that at least a portion of each wheel can engage the riser of a stair thus in use permitting the backpack to be pulled up stairs.

10. The wheeled backpack according to claim 2 including releasable securing means attaching the wheels to the one or more axles.

11. The wheeled backpack according to claim 10 in which the wheels carry indicia.

12. The wheeled backpack according to claim 2 including a compartment located within the bag portion and incorporating the one or more axles.

13. The wheeled backpack according to claim 2 wherein the wheels are attached to a common axle and including a hollow tube affixed to a lower portion of the body contacting side and in which the axle is located, and a padded section releasably held in place over the tube.

14. The wheeled backpack according to claim 13 including wet weather wheel protectors for reducing soiling of the back of a wearer of the backpack.
